(19) United States
(12) Patent Application Publication
(10) Pub. No.: US 2005/0047109 A1
(43) Pub. Date: Mar. 3, 2005

(54) Linear light-source module

(76) Inventors: Te Hsin Yi, Taipei City (TW); Chia Pin Yang, Chungho City (TW)

Correspondence Address: BIRCH STEWART KOLASCH & BIRCH, PO BOX 747, FALLS CHURCH, VA, 22040-0747, US

(21) Appl. No.: 10/656,232

(22) Filed: Sep. 8, 2003

(30) Foreign Application Priority Data
Aug. 29, 2003 (TW) 92215758

(51) Int. Cl. G01D 11/28

(52) U.S. Cl. 362/26; 362/551

(57) ABSTRACT

A linear light-source module includes a light-guide rod having a plurality of recesses concaved thereof, at least one lighting member disposed on at least one end of the light-guide rod and a reflecting member enclosing the light-guide rod. Regarding a front cross-section view of the light-guide rod, the recesses each forms downwardly deflecting a first predetermined angle from a centric-horizontal line in a radiation direction of the light-guide rod, crossing with a side surface of the light-guide rod; the reflecting member has an elongated opening formed on the side surface thereof and formed upwardly deflecting a supplementary angle, to the first predetermined angle, from the centric-horizontal line in the radiation direction of the light-guide rod, crossing with the side surface of the light-guide rod. The recesses are arranged linearly in an axial direction of the light-guide rod, and each is equilateral and has a second predetermined angle sandwiched therein.

### BACKGROUND OF THE INVENTION

### FIELD OF THE INVENTION

The present invention relates to a linear light-source module. More particularly, the present invention relates to a linear light-source module with a highly uniform light-guide rod.

### BACKGROUND OF THE INVENTION

A conventional light-guide rod uses various sizes of a plurality of dots and a high or low dot density to evenly spread the light the light-guide rod. Dot designs, which can be shaped like a circle, a V shape, a hexagon or a conic shape, are used to destruct the total internal reflection in the conventional light-guide rod and to evenly emit the light out of the conventional light-guide rod. Therefore, the dot design closely results in even diffusion of the light and high uniformity of the light-guide rod. There are more manufacturing steps about dot designs, which are conventionally formed by “Dot pattern” technology, such processes sequently are injection molding, printing, and curing; printing errors make the dot size difficult to control and thus the luminance and the uniformity reduce.

Hence, the prior art improved is required to overcome the disadvantages thereof.

### SUMMARY OF INVENTION

The object of the invention is therefore to specify a linear light-source module to increase reflection efficiency.

Another object of the invention is therefore to specify a linear light-source module, which light-guide rod is produced integrally in one piece and in an injection mold manner, to reduce costs and steps thereof and definitely raise the manufacturing efficiency.

According to the invention, this object is achieved by a linear light-source module including a light-guide rod having a plurality of recesses concaved thereof, at least one lighting member disposed on at least one end of the light-guide rod, and a reflecting member enclosing the light-guide rod. Regarding a front view of a cross-section of the light-guide rod, the recesses each forms on a joint of a deviation line, which downwardly deflects a first predetermined angle from a centric-horizontal line in a radiation direction of the light-guide rod, crossing with a side surface of the light-guide rod; the reflecting member has an elongated opening formed on the side surface thereof and formed upwardly deflecting a supplementary angle, to the first predetermined angle, from the centric-horizontal line in the radiation direction of the light-guide rod, crossing with the side surface of the light-guide rod. Wherein the recesses are arranged linearly in an axial direction of the light-guide rod, and each is concaved with a predetermined depth for controlling the reflection efficiency of the light-guide rod. The recesses each is equilateral and has a second predetermined angle sandwiched therein and made integrally in one piece with the light-guide rod 10 by an injection molding process.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a decomposition view of the present invention;

FIG. 2 is a perspective view of the present invention;

FIG. 3 is a cross section according to the present invention;

FIG. 4 is a perspective view according to a first embodiment of the present invention;

FIG. 4A is an enlarged view according to the first embodiment of the present invention; and

FIG. 5 is a perspective view according to a second embodiment of the present invention.

### DETAILED DESCRIPTION OF THE EMBODIMENTS

The present invention provides a linear light-source module adopted for an optical input device like a scanner, or an optical output apparatus like a printer. The linear light-source module includes a light-guide rod and a plurality of recesses formed on the light-guide rod, and uses a deflection angle with 45 degree for disposing thereof and a sandwiched angle with 90 degree to increase the reflection efficiency.

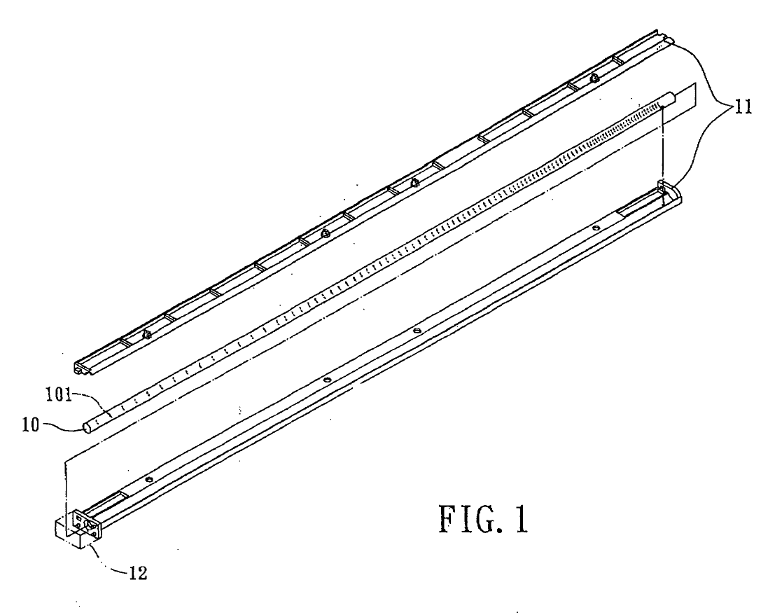

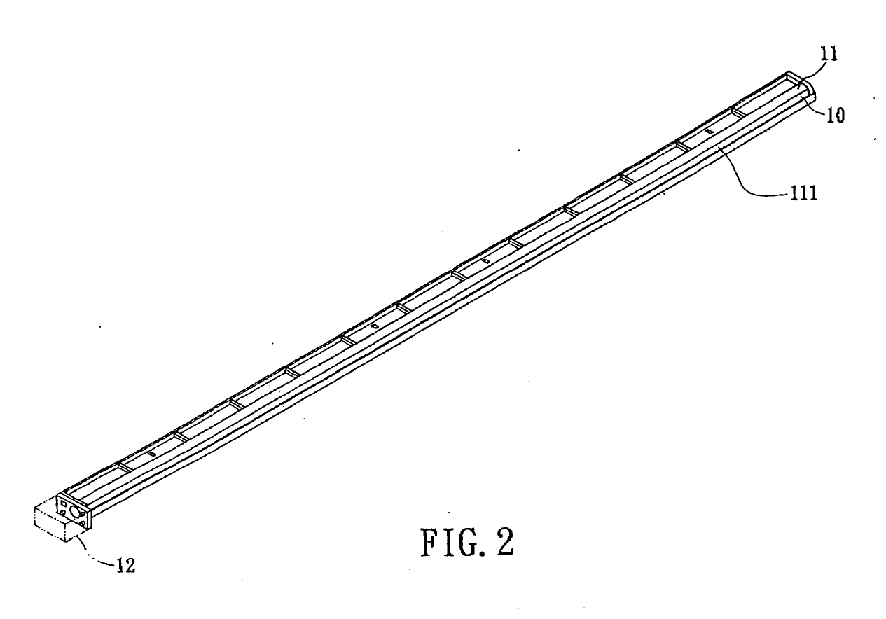

Referring to FIG. 1 and FIG. 2, the present invention provides a linear light-source module 1 of the decomposition view and the perspective view. The linear light-source module 1 includes a light-guide rod 10, a reflecting member 11 enclosing the light-guide rod 10, and at least one lighting member 12 disposed on at least one end of the light-guide rod 10. Regarding a front view of a cross-section of the light-guide rod 10, the light-guide rod 10 has a plurality of recesses 101 each forms on a joint of a deviation line, which downwardly deflects a first predetermined angle ‘α’ from a centric-horizontal line in a radiation direction of the light-guide rod 10, crossing with a side surface of the light-guide rod 10 for the recesses 101 destruct the total internal reflection generated in the light-guide rod 10. The recesses 101 are arranged linearly in an axial direction of the light-guide rod 10, and each is equilateral and has a second predetermined angle ‘θ’ sandwiched therein and made integrally in one piece with the light-guide rod 10 by an injection molding process. The recesses 101 each is concaved with a predetermined depth ‘d’ for controlling the reflection efficiency of the light-guide rod 10, and the reflection efficiency is best, when the first predetermined angle ‘α’ equals to 45 degree. Wherein the light-guide rod 10 is a crystalline material having a light transmission of more than about 90%, and furthermore the light-guide rod 10 is made of Polycarbonate (PC) or Polyacylate materials and the reflecting member 11 is made of the PC materials.

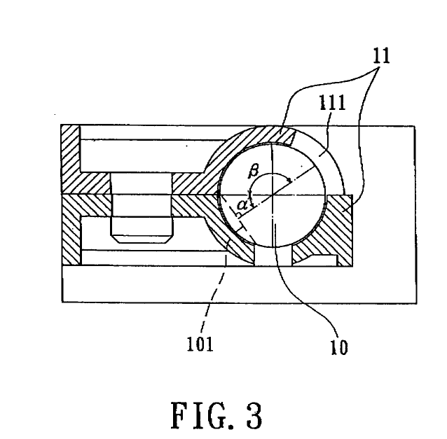

According to FIG. 3, the reflecting member 11 has an elongated opening 111 formed upwardly deflecting a supplementary angle ‘β’, to the first predetermined angle ‘a ’, from the centric-horizontal line in the radiation direction of the light-guide rod 10, crossing with the side surface of the light-guide rod 10 for linear lighting and being adopted for the optical input device or the optical output apparatus.

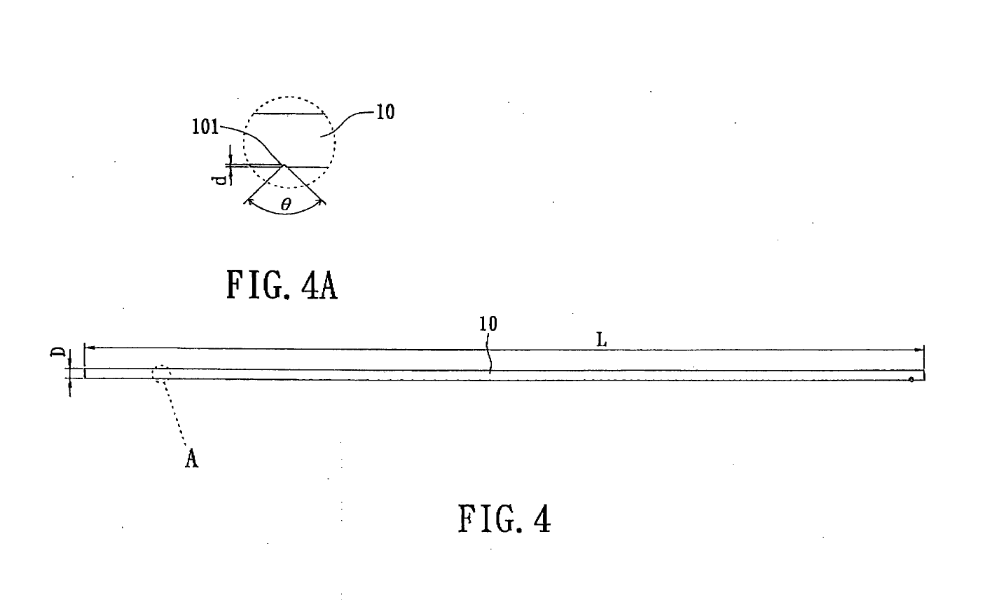

With respect to FIGS. 4 and 4A, the reflection efficiency is best when the second predetermined angle ‘θ’ is about 90 degree. The recesses 101 is made integrally in one piece with the light-guide rod 10 by an injection molding process, thus the present invention omits complex steps of the conventional light-guide rod to increase the manufacturing efficiency. The recesses 101 are disposed on the light-guide rod 10 and arranged in a “compressive front and rarefactional rear” manner relative to the lighting member 12 to evenly spread the light therein. The closer the recesses 101 near the lighting member 12 are, the more rare the arrangement of the recesses 101 is; on the contrary, if the recesses 101 are remote form the lighting member 12, the arrangement of the recesses 101 is compressed. That means, density of the recess 101 increases from a first end, which the lighting member 12 disposes, to a second end opposing to the first end.

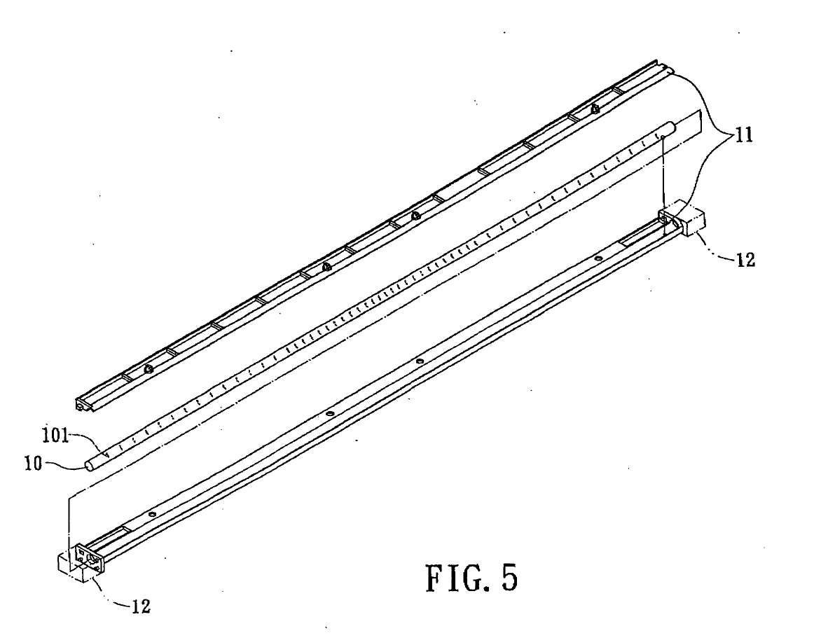

As illustrated in FIG. 5, a second embodiment of the present invention provides a pair of lighting members 12 respectively disposed on two opposing ends of the light-guide rod 10, the density of the recess 101 increases from each end thereof to a middle thereof.

As illustrated in FIG. 1 to 4, a first embodiment of the present invention discloses dimensions of length ‘L’ of the light-guide rod 10, thickness ‘D’ thereof, and the predetermined depth ‘d’. A ratio of the thickness ‘D’ to the predetermined depth ‘d’ is between about 30:1 to 20:1. Wherein the ratio is decided by maximums and minimums of the thickness ‘D’ and the predetermined depth ‘d’ relative to each other.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A linear light-source module comprising:
a light-guide rod having a plurality of recesses concave thereof and each, in view of a cross section thereof, formed on a joint of a deviation line, which downwardly deflects a first predetermined angle from a centric-horizontal line in a radiation direction of the light-guide rod, crossing with a side surface of the light-guide rod, wherein the recesses are arranged linearly in an axial direction of the light-guide rod, and the recesses each is concaved with a predetermined depth for controlling the reflection efficiency of the light-guide rod and equilateral to has a second predetermined angle sandwiched therein;
at least one lighting member disposed on at least one end of the light-guide rod; and
a reflection member enclosing the light-guide rod having an elongated opening formed on the side surface thereof and formed upwardly deflecting a supplementary angle, to the first predetermined angle, from the centric-horizontal line in the radiation direction of the light-guide rod, crossing with the side surface of the light-guide rod; wherein
the recesses are made integrally in one piece with the light-guide rod by an injection molding process, and the recesses arranged in a “compressive front and rarefactional rear” manner relative to the lighting member.

2. The linear light-source module of claim 1, wherein the lighting member is disposed on a first end of the light-guide rod, the light-guide rod has a recess density increasing from the first end to a second end opposing to the first end.

3. The linear light-source module of claim 1, wherein the lighting member is double to dispose on two opposing ends of the light-guide rod, the light-guide rod has a recess density increasing from each end to a middle thereof.

4. The linear light-source module of claim 1, wherein the light-guide rod is a crystalline material having a light transmission of more than about 90%.

5. The linear light-source module of claim 4, wherein the light-guide rod is made of Polycarbonate (PC), or Polyacylate materials

6. The linear light-source module of claim 1, wherein the reflecting member is made of Polycarbonate (PC) material.

7. The linear light-source module of claim 1, wherein the first predetermined angle deflected in the light-guide rod is about 45 degree.

8. The linear light-source module of claim 1, wherein the second predetermined angle sandwiched in each of the recess is about 90 degree.

9. The linear light-source module of claim 1, further includes a ratio of the thickness of the light-guide rod to the predetermined depth of eachrecesses is between about 30:1 to 20:1.
